(19) United States
(12) Patent Application Publication
(10) Pub. No.: US 2003/0208544 A1
(43) Pub. Date: Nov. 6, 2003

(54) Multifunction e-mail server

(75) Inventor: Kenneth J. Wilson, Edgewater Park, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Oki Data Americas, Inc., Mount Laurel, NJ

(21) Appl. No.: 10/020,409

(22) Filed: Oct. 30, 2001

(51) Int. Cl. G06F 15/16

(52) U.S. Cl. 709/206

(57) ABSTRACT

An apparatus for receiving an e-mail message and transmitting the e-mail message to one of a plurality of computers. The apparatus includes a memory having at least one region for storing computer executable program code; and a processor for executing the program code stored in said memory. The program code includes code for receiving the e-mail message, storing the e-mail message in a mailbox corresponding to a user-name, incrementing a counter representative of the number of e-mail messages which are stored in the mailbox, determining if an e-mail client corresponding to the user-name has formed a connection between the one of the plurality of computers and the server, transmitting the e-mail message to the one of the computers if the connection has been formed, and thereafter, deleting the e-mail message from the mailbox and decrementing the counter.

### BACKGROUND OF THE INVENTION

The present invention relates to an apparatus for distributing electronic messages to a plurality of addressees and more particularly to an apparatus and method for temporarily storing electronic mail messages and for notifying the addressees of the presence of the stored electronic mail messages in accordance with predetermined criteria.

Electronic mail (e-mail) is widely used to transmit correspondence and documents of all kinds. Particularly, the portion of the Internet known as the World Wide Web has shown rapid growth in providing e-mail services.

Access to users of the World Wide Web is generally provided by an Internet Service Provider (ISP). Among the services provided by an ISP is that of being an e-mail server. The e-mail server resident within an ISP stores e-mail messages received from other email servers elsewhere on the Internet that are addressed to subscribers of the ISP. The ISP stores the e-mail messages in a queue in a mailbox allocated to each user-name of the subscriber until the subscriber logs on to the server and downloads the messages.

Electronic mail systems operating on the Internet generally conform to either the Post Office Protocol version 3 (POP3) or the Messaging Access Protocol version 4 (IMAP4). Electronic mail systems utilizing the POP3 or IMAP4 protocols notify a subscriber when e-mail messages are stored in a mailbox allocated to the subscriber only when the subscriber causes a client computer or other e-mail downloading device to connect to the e-mail server, the connection is authenticated and a request for information about the stored e-mail messages is transmitted from the client computer to the server. Thus, in general, the subscriber is not made aware of the fact that e-mail messages addressed to the subscriber are stored in the server until the subscriber connects a client computer or other e-mail downloading device to the server and requests information about the messages. Furthermore, the POP3 and IMAP4 protocols themselves do not provide information about the contents of the stored messages, such that a subscriber could determine whether the message would be of value if it were downloaded from the server.

Small office/home office (SOHO) environments frequently have a relatively small number of computers, the users of which are individual subscribers of one or more remote ISPs. These computers may not be operational at all times. Thus, e-mail messages addressed to the users of the computers must be stored in the respective ISPs until the computers form an authenticated connection with the ISP. Further, the subscribers have no way of knowing whether there are any e-mail messages queued for them until the connection to the ISP is formed.

There are known Internet gateway devices such as the Netline™ Wireless Broadband Gateway or the Pizzabox™ Internet Gateway which allow a plurality of computers configured on a local area network to share a single connection to an ISP. The gateway devices also function as an e-mail servers, thus transferring the burden of storing the messages addressed to the subscribers of the ISP from the ISP to the gateway device. However, the known Internet gateway devices do not notify users of the existence or the number of messages stored in the Internet gateway device when the users have not previously formed a connection with the device; nor do the devices provide the capability of screening incoming e-mail messages with a predetermined criteria to: (1) selectively notify a subscriber of an e-mail message which matches the predetermined criteria or (2) selectively forward the e-mail message to a predetermined addressee based on the e-mail message matching the predetermined criteria.

U.S. Pat. No. 6,035,104 is directed to a system for receiving and forwarding email messages to a subscriber. Each e-mail message is screened in an e-mail server for predetermined characteristics provided by the subscriber. The subscriber is notified of stored messages meeting the predetermined characteristics by the e-mail server transmitting a notification message to a pager belonging to the subscriber. Upon receiving the notification message, the subscriber may respond by selecting a specific forwarding address for the e-mail message. Thus, U.S. Pat. No. 6,035,104 requires that instructions for forwarding the e-mail message be provided by the recipient of the notification message at the time the recipient receives the notification.

U.S. Pat. No. 5,917,489 is directed to a desktop information manager for processing electronic messages received by an e-mail client. The information manager provides for creating rules for responding to or forwarding the e-mail messages received by the e-mail client according to the contents of the e-mail message. Certain of the rules may be uploaded to an e-mail server. However, no provision is made for notifying a user of the presence of messages stored in the e-mail server or of the presence of messages stored in the server that meet a predetermined criteria until the user actually connects with the server.

It would be desirable to have a device which could relieve an ISP of the burden of storing e-mail messages addressed to a prescribed set of users. It would further be desirable to be able to apprise users of the presence of one or more e-mail messages which are stored in the device, the number of messages which are stored in the device and whether the messages have met a predetermined criteria without the user having to first connect to the device. It is to these and other related objects that the present invention is directed.

### BRIEF SUMMARY OF THE INVENTION

Briefly stated, the present invention comprises an apparatus for receiving an e-mail message and for transmitting the e-mail message to one of a plurality of computers. The apparatus includes a memory having at least one region for storing computer executable program code, and a processor for executing the program code stored in said memory. The program code includes code for receiving the e-mail message, storing the e-mail message in a mailbox corresponding to a user-name, incrementing a counter representative of the number of e-mail messages which are stored in the mailbox, determining if an e-mail client corresponding to the user-name has formed a connection between the one of the plurality of computers and the server, transmitting the e-mail message to the one of the computers if the connection has been formed, and thereafter, deleting the e-mail message from the mailbox and decrementing the counter.

The present invention further comprises a method for transmitting an e-mail message received by a server to one of a plurality of computers. The method comprises the steps of: receiving the e-mail message in the server; storing the e-mail message in a mailbox corresponding to a user-name; incrementing a counter representative of the number of e-mail messages which are stored in the mailbox; determining if an e-mail client corresponding to the user-name has formed a connection between the one of the plurality of computers and the server; transmitting the e-mail message to the one of the computers if the connection has been formed; and deleting the e-mail message from the mailbox and decrementing the counter after the e-mail message has been transmitted.

The present invention also includes a method for interacting with a client computer and setting outcome criteria and outcome instructions in an e-mail server connected to the client computer. The method comprises: logging in to the e-mail server with a username; receiving a configuration page from the e-mail server; entering the outcome criteria into the configuration page; entering the outcome instructions into the configuration page; and submitting the configuration page to the e-mail server.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a functional block diagram of a system, including an e-mail server, according to a preferred embodiment of the present invention;

FIG. 2 is a more detailed functional block diagram of the e-mail server shown in FIG. 1;

FIG. 3 is a diagram of the major software modules which constitute computer code of the preferred embodiment;

FIG. 4 is a pictorial diagram of a screen display for configuring outcome criteria and outcome instructions to be applied to an e-mail message received by the e-mail server;

FIG. 5a is a flow diagram of a process for receiving and storing an e-mail message in a mailbox within the e-mail server;

FIG. 5b is a flow diagram of a process for retrieving the stored e-mail message from the mailbox, applying the outcome criteria and the outcome instructions to the retrieved email message and for updating a status of the mailbox;

FIG. 6 is a more detailed flow diagram of the process for applying the outcome criteria to the e-mail message retrieved from the mailbox; and

FIG. 7 is a more detailed flow diagram of the process for applying the outcome instructions to the e-mail message retrieved from the mailbox.

### DETAILED DESCRIPTION OF THE INVENTION

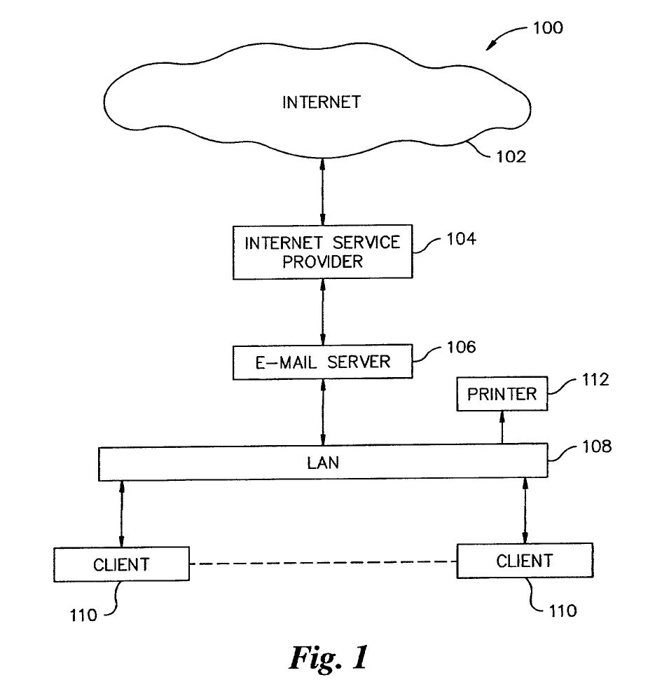

Referring to the drawings, wherein like numerals are used to indicate like elements throughout the several figures and the use of the indefinite article “a” may indicate a quantity of one, or more than one, of an element, there is shown in FIG. 1 a block diagram of a system 100 for transmitting electronic mail (e-mail) between host computers (not shown) connected to a publicly accessible wide area network well known as the Internet 102, and a plurality of client computers 110, in accordance with a preferred embodiment of the present invention.

Preferably, the client computers 110 are the type of computers known as personal computers having a central processing unit, a memory, a display and a keyboard. However, the client computers 110 need not be personal computers but could be any other type of devices which are capable of receiving e-mail messages, such as so called Internet appliances, lap top computers, hand held computers, palm devices etc.

The plurality of client computers 110 transmit e-mail to the Internet 102 and receive e-mail from the Internet 102 via an Internet Service Provider (ISP) 104. In the preferred embodiment, an e-mail server 106 is interposed between the ISP 104 and the plurality of client computers 110.

Preferably, the e-mail server 106 is located in the vicinity of the client computers 110 so that the users of the client computers 110 could visually or aurally receive annunciation signals transmitted from the e-mail server 106. However, it is not necessary to place the e-mail server 106 in the vicinity of the client computers 110 in order for the e-mail server 106 to perform its stated functionality.

Preferably, the plurality of client computers 110 are connected to the e-mail server 106 by a local area network (LAN) 108. Preferably the LAN 108 is a 100BaseT local area network compliant with IEEE Std. 802.3. However, the system 100 is not limited to using a 100BaseT local area network for connecting the e-mail server 106 to the various client computers 110. As will be appreciated by those skilled in the art, other types of local area networks, such as a token ring network compatible with IEEE 802.5, may be used for connecting the e-mail server 106 to the client computers 110. Further, the e-mail server 106 could be connected directly to the client computers 110 by well known parallel or serial connections. The principles by which information is transferred between the e-mail server 106 and the client computers 110 are well known to those skilled in the art and need not be described here for a full understanding of the invention.

In the preferred embodiment one or more printers 112 of a known kind are connected to the LAN 108. The printers 112 are used to print selected e-mail messages, documents etc. as described below.

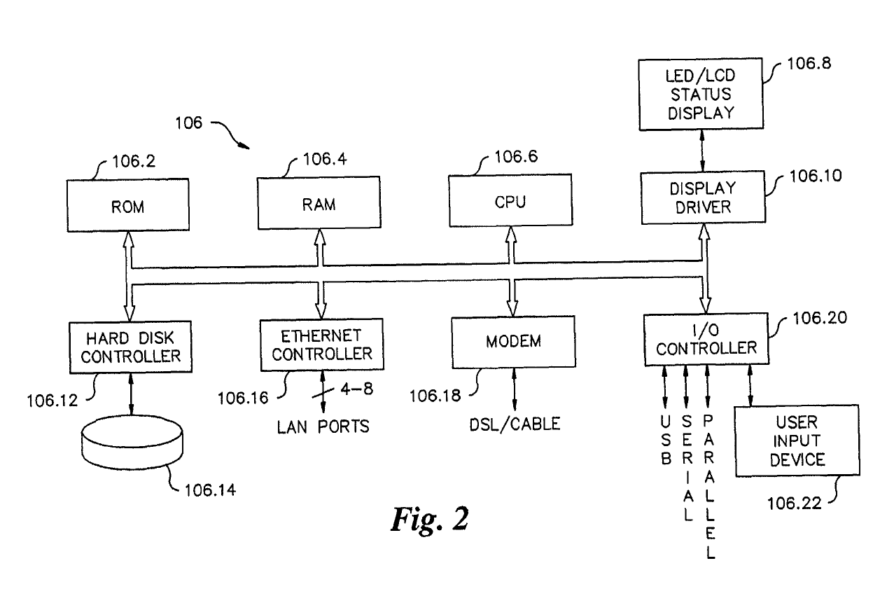

Referring now to FIG. 2 there is shown a functional block diagram of the e-mail server 106 in accordance with the preferred embodiment. Preferably, the e-mail server 106 includes a central processing unit (CPU) 106.6 for executing program code, a read only memory (ROM) 106.2 for storing executable program code, a random access memory (RAM) 106.4 for temporarily storing the executable program code, and a system bus 106.24 that couples the CPU 106.6 to the RAM 106.4 and the ROM 106.2. A basic input/output system (BIOS) containing the basic routines that help to transfer information between the elements of the e-mail server 106, such as start up, is included in the ROM 106.2. The e-mail server 106 further includes a hard disk 106.14, which is controlled by a hard disk controller 106.12 connected to the system bus 106.24. The preferred embodiment also includes a user input device 106.22 for entering commands into the e-mail server 106. Preferably, the user input device 106.22 is a keypad connected to the CPU 106.6 via an I/O controller 106.20 and the system bus 106.24. Preferably, the I/O controller 106.20 includes one or more serial ports, parallel ports and USB ports for connecting other input devices and output devices such as a printer, a keyboard etc. to the e-mail server 106.

Preferably, the e-mail server includes a display 106.8 including light emitting diode (LED) annunciators (not shown) for announcing events. The display 106.8 also includes a liquid crystal alpha-numeric display (LCD) (not shown) for providing status indications, such as the number of e-mail messages stored within the e-mail server 106 for a particular e-mail user-name. Other types of annunciators for announcing events may be used, such as audio alert devices.

The e-mail server 106 further includes a modem 106.18. Preferably, the modem 106.18 is a cable modem for interfacing the e-mail server 106 to a broadband cable system by appropriately modulating upstream electrical signals and demodulating downstream electrical signals in accordance with industry standards such as the Data-Over-Cable Service Interface Specifications (DOCSIS) Radio Frequency Interface Specification. Alternatively, the modem 106.18 could be another type of modem, depending on the type of medium used to connect the e-mail server 106 to the ISP 104. Such a modem type could be, but is not limited to, a DSL modem, a T1 modem, or a dial-up wireline or a wireless modem. Modems of the types described are well known and are not further described here for the sake of brevity.

The preferred embodiment also includes an Ethernet controller 106.16, for connecting the e-mail server 106 to the plurality of client computers 110. Ethernet controllers are well known and need not be described here for a full understanding of the invention.

Preferably, the e-mail server 106 is a stand alone device which connects directly to an ISP 104 via a broadband cable system and provides electrical connections to the plurality of computers 110 via the LAN 108. However, the e-mail server 106 could also connect to and utilize an existing cable modem in a cable set top box, or a DSL modem previously installed in a customer's premises for connection to the ISP 104. Alternatively, the e-mail server 106 could be incorporated within the cable set top box or within a personal computer, where hardware and/or software elements of the e-mail server 106 which are common with the set top box or the personal computer could be shared.

The e-mail server 106 includes computer code (i.e. software) for receiving an email message, storing the e-mail message in a mailbox corresponding to a user-name, incrementing a counter representative of the number of e-mail messages which are stored in the mailbox, determining if an e-mail client corresponding to the user-name has formed a connection between the one of the plurality of computers and the server, transmitting the e-mail message to the one of the computers if the connection has been formed, and thereafter, deleting the e-mail message from the mailbox and decrementing the counter. The e-mail server 106 further includes code for scanning the e-mail message stored in the mailbox to determine if a text string within the e-mail message meets a predetermined outcome criteria. The e-mail server also includes computer code for executing a predetermined outcome if the e-mail message meets the predetermined outcome criteria, where the outcome may be that of activating an annunciator if the e-mail message meets the outcome criteria, and that of transmitting the e-mail message to a forwarding address if the e-mail message meets the outcome criteria.

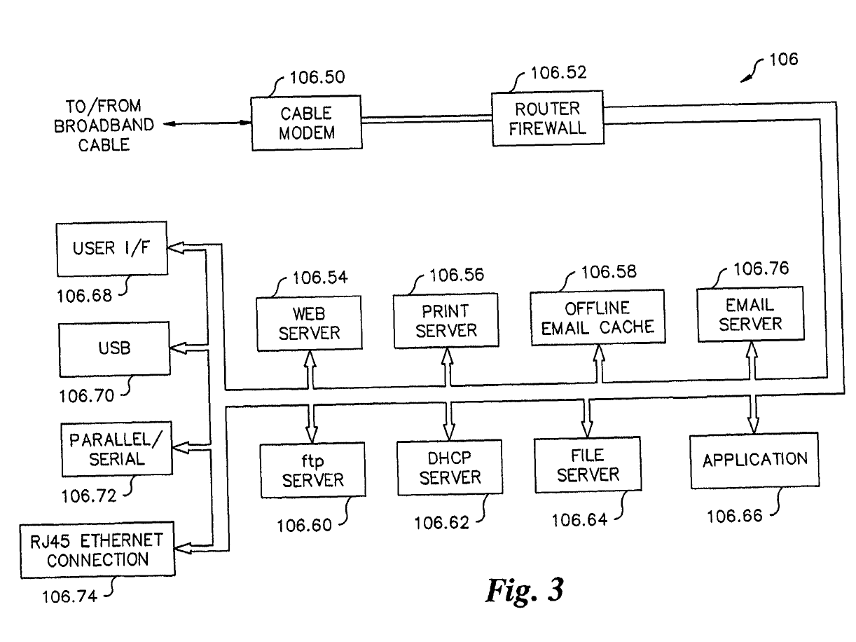

Referring now to FIG. 3 there is shown a diagram of the major software modules constituting computer code which executes within the preferred embodiment of the e-mail server 106. Preferably, the computer code includes:

a. Modem module 106.50—The cable modem software module 106.50 executes the control protocols for establishing a communication path between the e-mail server 106 and the head end of the broadband cable system. Preferably, the cable modem software conforms to the DOCSIS standard.

b. Router/Firewall module 106.52—The router/firewall software module 106.52 provides security for the client computers 110 by supporting network address translation (NAT) in the e-mail server 106. The router/firewall ensures that unwanted TCP/IP ports are closed, provides rules for forwarding e-mail to the client computers 110 and rules for allowing access to ftp services maintained on the e-mail server 106 for ftp clients residing on the Internet.

c. Web Server module 106.54—The web server 106.54 generates web pages for configuring the e-mail server 106 by a user of each of the client computers 110. The web server module generates: (1) a user registration page which allows each user of a client computer 110 to create one or more mailboxes in the e-mail server 106 corresponding to one or more user-names selected by each user, and (2) a rule configuration page for establishing outcome criteria and outcome instructions to be applied to e-mail messages received by the e-mail server 106 and stored in the mailboxes within the e-mail server 106.

d. Print Server module 106.56—The print server module 106.56 accepts requests from the user input device 106.22 via the User I/F 106.68 and from the client computers 110 to queue e-mail messages stored in an e-mail mailbox for printing on the printer 112.

e. Email Server module 106.76—The Email server 106.76 utilizes POP3 or IMAP protocols for serving e-mail to the client computers 110 for each mailbox represented by the Off-line e-mail cache.

f. Off-line e-mail cache module 106.58—The Off-line cache module includes an email cache in spool directories of each mailbox for the e-mail messages to be printed on the printer 112, or to be downloaded to the client computers 110.

g. ftp Server Module 106.60—The ftp server module 106.60 supports File Transport Protocol (ftp) for the clients computers 110, as well as providing ftp support to those ftp clients on the Internet which are allowed access by the firewall to the e-mail server 106.

h. DHCP (Dynamic Host Configuration Protocol) server module 106.62—The DHCP server module 106.62 assigns each client computer 110 a temporary IP address each time the client computer 110 establishes a connection with the email server 106.

i. File server module 106.64.—The file server module 106.64 provides file sharing for the client computers 110 to access files stored in the e-mail server via native open systems protocols such as Netbios (via a TCP connection) and Appletalk (via an Ethernet connection).

j. Application module 106.66—The application software module 106.66 includes software for executing the predetermined outcome criteria and the predetermined outcomes associated with the outcome criteria. The application software module also includes a counter associated which each mailbox for maintaining a count of the number of e-mail messages stored in each associated mailbox. The count is displayed by the User I/F hardware.

k. User I/F module 106.68—The user interface software module 106.68 controls the local displaying/printing of an e-mail cache for each mailbox and actuates the annunciators based on the outcome criteria and the outcome instructions.

l. USB I/F module 106.70 The USB module software 106.70 provides a hardware and a software port/IRQ address for use by the Printserver module.

m. Parallel serial I/F module 106.72—The Parallel I/F module software 106.72 provides a hardware and a software port/IRQ address for use by the Printserver module.

n. RJ45 Ethernet I/F module 106.74—The Ethernet module provides hardware and software port/IRQ for TCP/IP connections.

The preferred embodiment provides the capability for a user to configure the email server 106 in order to: (1) establish an account having one or more user-names with the email server and (2) establish predetermined outcome criteria and predetermined outcome instructions for selected e-mail messages received by the e-mail server 106 and addressed to a user-name belonging to the user.

Preferably, a user connects with the e-mail server 106 to establish an account with the e-mail server 106 using a known procedure, which in general, includes security measures such as passwords to restrict access to the e-mail server 106 to authorized individuals. Following the establishment of the account, the user establishes one or more user-names and passwords in the e-mail server 106, wherein each user-name is uniquely associated with a mailbox in the e-mail server 106. Having established one or more mailboxes, the user logs in to the e-mail server 106 and requests a rule configuration page for establishing outcome criteria and outcome instructions for user selected e-mail messages which are to be received by the email server 106 and are addressed to one of the user-names belonging to the user.

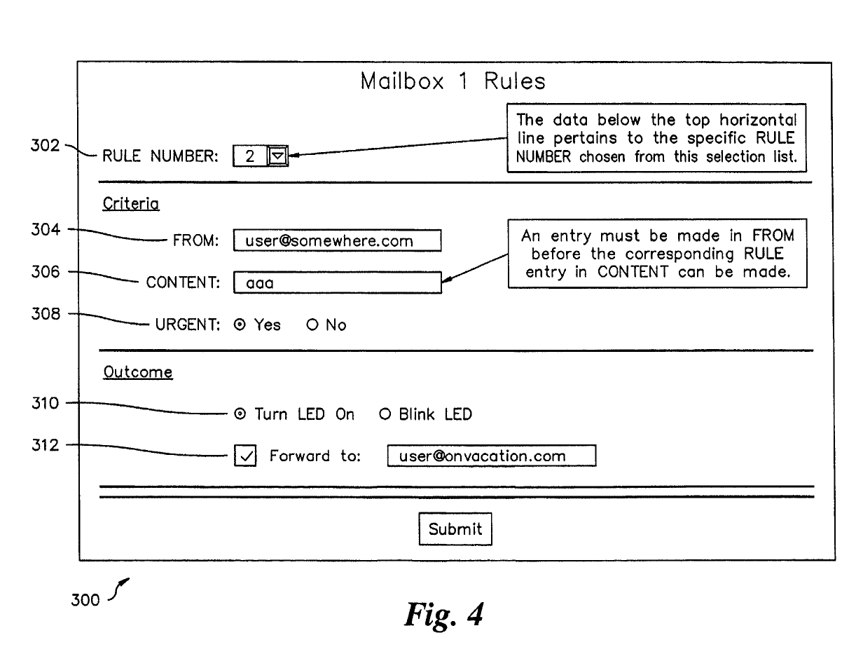

Preferably, the rule configuration page is a web page generated by the e-mail server 106. As shown in FIG. 4, the rule configuration page 300 provides the user with input fields 302-312 for entering the outcome criteria and the outcome instructions for each mailbox/user-name for which the user has access. The user submits the configuration page to the e-mail server 106 after entering the outcome criteria and the outcome instructions. In configuring the rule configuration page 300, a user:

a. Enters a rule number in the RULE NUMBER input field 302;

b. Enters an outcome criteria in the FROM input field 304 comprising a text string in the “from” field of the e-mail message. The criteria may apply separately to the fields on the left side and the right side of the @ sign in the “from” field. A wild card character, e.g. “*” may be used on either the left side, the right side or on both sides of the @ sign in the “from” field of the e-mail message. If a text string (including wild card characters) is not entered into the “FROM” input field for a particular rule, the rule is not valid.

c. Enters an outcome criteria in the CONTENT input field 306 comprising a text string of the e-mail message other than the “from” field in addition to the text string in the “from” field. If a text string is not entered in the CONTENT input field 306, the CONTENT input field 306 is ignored.

d. Enters an outcome criteria in the URGENT input field 308 for detecting a flag character in the priority field or in the X-priority field of the header of the e-mail message indicating that the e-mail message is “urgent”. If no entry is made in the URGENT field 308, the URGENT input field 308 is ignored.

e. Enters in the OUTCOME ANNUNCIATOR input field 310 whether an e-mail message meeting all of the criteria of b, c and d above should cause the output from the annunciator to be steady or interrupted.

f. Enters in the FORWARD input field 312 whether an e-mail message meeting the criteria of b, c and d above is to be forwarded to another address.

g. Enters in the FORWARD TO ADDRESS input field 314 the forwarding address for the e-mail message meeting all of the criteria b, c, d and f above.

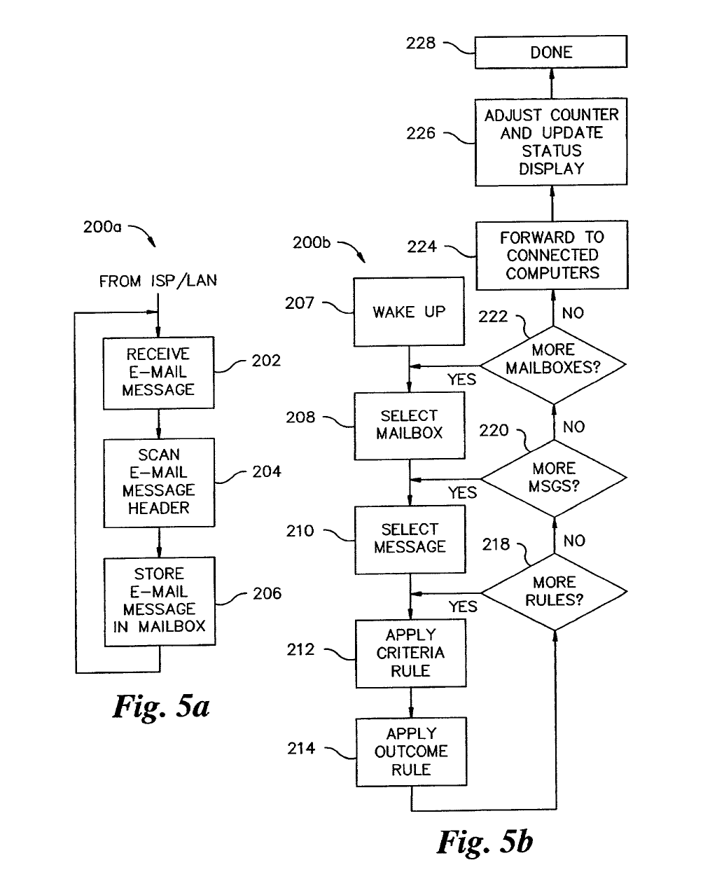

Referring now to FIGS. 5a and 5b there is shown preferred processes 200a, 200b for processing an e-mail message received by the e-mail server 106 from the ISP 104 or from a client computer 110 connected to the e-mail server 106 via the local area network 108. The process 200a comprises receiving the e-mail message in the e-mail server 106 (step 202) using any one of the known e-mail communication protocols such as simple mail transfer protocol (SMTP). Following receipt of the e-mail message, the header of the received e-mail message is scanned (step 204) to determine if the addressee of the received e-mail message corresponds to a user-name associated with a mailbox in the e-mail server 106. If the addressee of the received e-mail message corresponds to the user-name of a mailbox in the e-mail server 106, the e-mail message is stored in the corresponding mailbox (step 206), otherwise the e-mail message is discarded and an error message is transmitted back to the originator of the e-mail message.

In executing the process 200b, the e-mail server 106 periodically wakes up (step 207) and selects each new e-mail message in each mailbox. The e-mail server 106 applies the predetermined outcome criteria and the predetermined outcome instructions to each new e-mail message stored in each mailbox (steps 208-222). Each iteration of the process 200b selects a mailbox (step 208 and 222), selects each new message in the selected mailbox (steps 210 and 220) and applies the outcome criteria and outcome instructions (if applicable) to each selected new e-mail message (steps 212, 214 and 218).

The e-mail server 106 applies as many outcome criteria and outcome instructions to each new message as have been entered into the e-mail server 106. The multiple outcome criteria and outcome instructions may result in a different outcome for each outcome criteria that is met.

At the conclusion of steps 208 to 222, the e-mail server determines if any of the client computers 110, having an e-mail client user-name corresponding to one of the mailboxes, has formed a connection with the e-mail server 106. The e-mail server 106 transmits the e-mail messages stored in the various mailboxes to each corresponding client computer 110 which has formed a connection and deletes the e-mail message from the respective mailbox (step 224). The e-mail server then adjusts the count in the counter associated with each mailbox to represent the number of e-mail messages stored in each mailbox. Preferably, the number of email messages stored in each mailbox is displayed on the status display 106.8 on the front panel of the e-mail server 106 (step 226). The e-mail server 106 then suspends execution for a predetermined time (step 228).

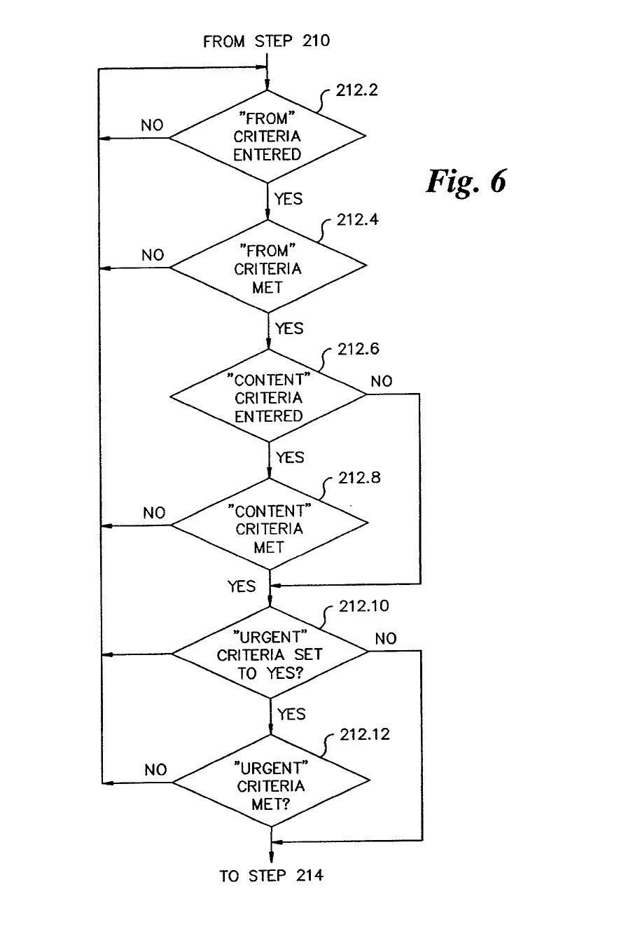

Referring now to FIG. 6, there is shown a flow diagram of details of the process 212 for applying a rule to an e-mail message stored in a mailbox according to an arbitrary rule number. At step 212.2, the “FROM” field 304 of the configuration page 300 is examined to determine if a data entry has been made. If no data has been entered into the “FROM” field, the next rule is selected. If a data entry in the “FROM” field 304 has been made, the “from” field in the header of the e-mail message is compared with the data entry in the “FROM” field 302 (step 212.4). If the “FROM” criteria is not met, the next rule is selected. If the “FROM” criteria is met, i.e. the character string in the “from” field of the e-mail message is identical to the data entry in the “FROM” field 304 of the configuration page 300, the e-mail message is then examined to determine if a data entry in the “CONTENTS” field 306 has been made (step 212.6). If no data has been entered into the “CONTENTS” field, the “urgent’ criteria (step 212.10) is next examined. If a data entry in the “CONTENTS” field 306 has been made, the text of both the header and the body of the e-mail message are compared with the data entry in the “CONTENTS” field 304 (step 212.8). If the “CONTENTS” criteria is not met, the next rule is selected. If the “CONTENTS” criteria is met, i.e. a character string in the e-mail message is identical to the data entry in the “CONTENTS” field 306 of the configuration page 300, the e-mail message is then examined to determine if the “URGENT” field 308 has been SET TO “yes” (step 212.10). If the “URGENT” field 308 has not been set to “yes”, the process continues with the outcome instructions (step 214). If the “URGENT” field 308 has been set to “yes”, the urgent fields in the header of the e-mail message are examined for the urgent flag (step 212.12). If one of the urgent fields in the e-mail message includes the urgent flag, the process continues at step 214. If one of the urgent fields in the e-mail message does not include the urgent flag, the next rule is selected.

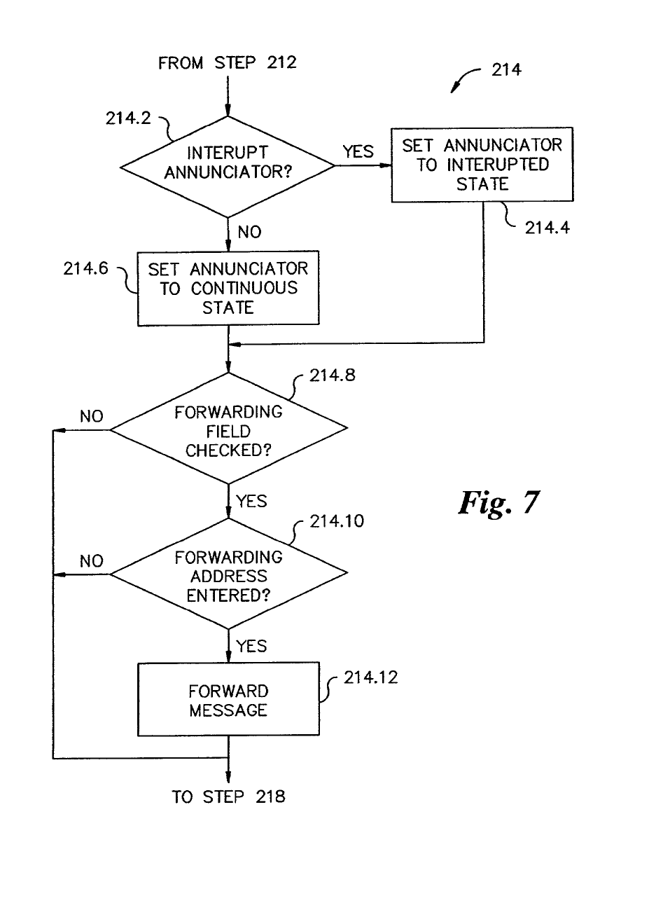

Referring now to FIG. 7, there is shown details of the process 214 for applying outcome instructions to an e-mail message that has met the outcome criteria established in step number 212. At step 214.2, the outcome annunciator field 310 is examined to determine if the annunciator should provide an interrupted or a continuous announcement. The annunciator is then placed in the interrupted state (step 214.4) or the continuous state (214.6) depending on whether the annunciator outcome instruction was selected for the annunciator to be in the continuous state or in the interrupted state. At step 214.8, the “FORWARDING” field 312 is checked to determine if the e-mail message should be forwarded. If the “FORWARDING” field 312 is checked (step 214.8) and the forwarding address is entered (step 214.10), the e-mail message is forwarded (step 214.12). If either the “FORWARDING” field 312 is not checked (step 214.8) or the forwarding address is not entered (step 214.10), the e-mail message is not forwarded. The forwarded e-mail message may be forwarded to another mailbox in the e-mail server 106, to a client computer 110, to a host computer connected to the Internet 102 or to the printer 112.

As made clear in this disclosure, the present invention is a device for temporarily storing a plurality of e-mail messages in a mailbox associated with a user-name, and for providing a notification of the presence of one or more e-mail messages in the mailbox, the number of e-mail messages which are stored in the mailbox and whether any of the e-mail messages meet a predetermined criteria.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. In a system comprising an e-mail server and a plurality of computers connected to the server, a method for transmitting an e-mail message received by the server to one of the plurality of computers, the method comprising the steps of:
receiving the e-mail message in the server;
storing the e-mail message in a mailbox corresponding to a user-name;
incrementing a counter representative of the number of e-mail messages which are stored in the mailbox;
determining if an e-mail client corresponding to the user-name has formed a connection between the one of the plurality of computers and the server;
transmitting the e-mail message to the one of the computers if the connection has been formed; and
deleting the e-mail message from the mailbox and decrementing the counter after the e-mail message has been transmitted.

2. The method according to claim 1, further including the step of scanning the e-mail message stored in the mailbox to determine if a text string within the e-mail message meets a predetermined outcome criteria.

3. The method according to claim 2, wherein the text string comprises a “from” address.

4. The method according to claim 2, wherein the text string includes a “from” address and a text string other than the “from” address.

5. The method according to claim 2, wherein the text string includes a “from” address and an “urgent” flag.

6. The method according to claim 2, further including the step of causing a predetermined outcome if the text string meets the outcome criteria.

7. The method according to claim 6, wherein the outcome comprises activating an annunciator.

8. The method according to claim 6, wherein the outcome comprises forwarding the message to an addressee.

9. The method according to claim 6, further including the step of the server receiving a description of the outcome criteria and the outcome from the one of the plurality of computers.

10. An apparatus for receiving an e-mail message and transmitting the e-mail message to one of a plurality of computers comprising:
a memory having at least one region for storing computer executable program code; and
a processor for executing the program code stored in said memory, wherein the program code includes code for receiving the e-mail message, storing the e-mail message in a mailbox corresponding to a user-name, incrementing a counter representative of the number of e-mail messages which are stored in the mailbox, determining if an e-mail client corresponding to the user-name has formed a connection between the one of the plurality of computers and the server, transmitting the e-mail message to the one of the computers if the connection has been formed, and thereafter, deleting the e-mail message from the mailbox and decrementing the counter.

11. The apparatus according to claim 10, wherein the program code further includes code for scanning the e-mail message stored in the mailbox to determine if a text string within the e-mail message meets a predetermined outcome criteria.

12 The apparatus according to claim 11, wherein the program code further includes code for executing a predetermined outcome if the e-mail message meets the outcome criteria.

13. The apparatus according to claim 12, wherein the program code further includes code for activating an annunciator if the e-mail message meets the predetermined outcome criteria.

14. The apparatus according to claim 12, wherein the program code further includes code for transmitting the e-mail message to a forwarding address if the e-mail message meets the outcome criteria.

15. A method for interacting with a client computer and setting outcome criteria and outcome instructions in an e-mail server connected to the client computer, the method comprising:
logging in to the e-mail server with a user-name;
receiving a configuration page from the e-mail server;
entering the outcome criteria into the configuration page;
entering the outcome instructions into the configuration page; and
submitting the configuration page to the e-mail server.

16. A method according to claim 15, wherein the outcome criteria comprises a “from” address.

17. A method according to claim 15, wherein the outcome criteria includes a text string.

18. A method according to claim 15, wherein the outcome criteria includes an “urgent” flag.

19. A method according to claim 15, wherein the outcome instructions include instructions for activating an annunciator.

20. A method according to claim 15, wherein the outcome instructions include the address of an addressee for receiving the e-mail message.
